(19) United States
(12) Patent Application Publication
(10) Pub. No.: US 2014/0019394 A1
(43) Pub. Date: Jan. 16, 2014

(54) PROVIDING EXPERT ELICITATION

(71) Applicants: Ramanan LAXMINARAYAN, Bethesda, MD (US); Roger Cooke, Washington, DC (US); Abigail Colson, Chicago, IL (US); Griffin Lenoir, Washington, DC (US); Itamar Megiddo, Washington, DC (US)

(72) Inventors: Ramanan LAXMINARAYAN, Bethesda, MD (US); Roger Cooke, Washington, DC (US); Abigail Colson, Chicago, IL (US); Griffin Lenoir, Washington, DC (US); Itamar Megiddo, Washington, DC (US)

(73) Assignee: Center for Disease Dynamics, Economics & Policy, Inc.

(21) Appl. No.: 13/547,634

(22) Filed: Jul. 12, 2012

(51) Int. Cl. G06N 5/00

(52) U.S. Cl. 706/45

(57) ABSTRACT

Systems and methods of providing expert elicitation are provided. Expert information may be stored in an expert database. A request for expert opinion may be received. A plurality of experts may be selected. A plurality of seed questions and target questions may be generated and sent to the experts selected. Answers to the questions may be received. A performance-based weight may be assigned to each expert based on the answers of the seed questions. Expert opinion may be generated based on the performance-based weight and answers to the target questions. The expert opinion may be provided.

### SUMMARY

Implementations of the systems and methods for providing expert elicitation are described herein. One implementation is a computerized method of providing expert elicitation via a computer network. The method includes storing a plurality of expert information to an expert database, wherein the expert information comprises at least one of areas of expertise, contact information, active and inactive fields, or projects working and worked on. The method also includes receiving, by at least one processing circuit, a request for an expert opinion from a user via the computer network. The method further includes selecting a plurality of experts based on information in the request of the user and generating a plurality of seed questions and target questions based on information in the request of the user. The method also includes sending the plurality of seed questions and target questions to each of the experts selected. Furthermore, the method includes receiving answers of the seed questions and the target questions from each of the experts. The method also includes assigning, by the at least one processing circuit, a performance-based weight to each of the experts based on the answers of the seed questions. The method additionally includes generating, by the at least one processing circuit, the expert opinion based on the performance-based weight of each of the experts and the answers to the target questions. The method also includes providing the expert opinion to the user.

Another implementation is a system of providing expert elicitation via a computer network. The system includes a processing circuit operative to store a plurality of expert information to an expert database, wherein the expert information comprises at least one of areas of expertise, contact information, active and inactive fields, or projects working and worked on. The processing circuit is also operative to receive a request for an expert opinion from a user via the computer network. The processing circuit is further operative to select a plurality of experts based on information in the request of the user and generate a plurality of seed questions and target questions based on information in the request of the user. The processing circuit is also operative to send the plurality of seed questions and target questions to each of the experts selected. The processing circuit is additionally operative to receive answers of the seed questions and the target questions from each of the experts. Furthermore, the processing circuit is operative to assign a performance-based weight to each of the experts based on the answers of the seed questions. The processing circuit is also operative to generate the expert opinion based on the performance-based weight of each of the experts and the answers to the target questions. The processing circuit is additionally operative to provide the expert opinion to the user.

A further implementation is a computer-readable medium having machine instructions stored therein, the instructions being executable by one or more processors to cause the one or more processors to perform operations. The operations include storing a plurality of expert information to an expert database, wherein the expert information comprises at least one of areas of expertise, contact information, active and inactive fields, or projects working and worked on. The operations also include receiving, by at least one processing circuit, a request for an expert opinion from a user via the computer network. The operations further include selecting a plurality of experts based on information in the request of the user and generating a plurality of seed questions and target questions based on information in the request of the user. The operations also include sending the plurality of seed questions and target questions to each of the experts selected. Furthermore, the operations include receiving answers of the seed questions and the target questions from each of the experts. The operations also include assigning a performance-based weight to each of the experts based on the answers of the seed questions. The operations additionally include generating the expert opinion based on the performance-based weight of each of the experts and the answers to the target questions. The operations also include providing the expert opinion to the user.

### BRIEF DESCRIPTION OF THE DRAWINGS

The details of one or more implementations of the subject matter described in this specification are set forth in the accompanying drawings and the description below. Other features, aspects, and advantages of the subject matter will become apparent from the description, the drawings, and the claims.

FIG. 1 illustrates a block diagram of an example system of providing expert elicitation via a computer network, according to an illustrative implementation.

FIG. 2 illustrates an exemplary expert database user interface, according to an illustrative implementation.

FIG. 3 illustrates an exemplary user interface for generating seed questions and target questions, according to an illustrative implementation.

FIG. 4 illustrates an exemplary user interface for an elicitation session, according to an illustrative implementation.

FIG. 5 is a flow diagram of a process for proving expert elicitation via a computer network, according to an illustrative implementation.

Like reference numbers and designations in the various drawings indicate like elements.

### DETAILED DESCRIPTION

The various concepts introduced above and discussed in greater detail below may be implemented in any of numerous ways, as the described concepts are not limited to any particular manner of implementation. Examples of specific implementations and applications are provided primarily for illustrative purposes. More detailed descriptions of various concepts related to, and embodiments of, methods, apparatuses, and systems for providing expert elicitation via a computer network are provided.

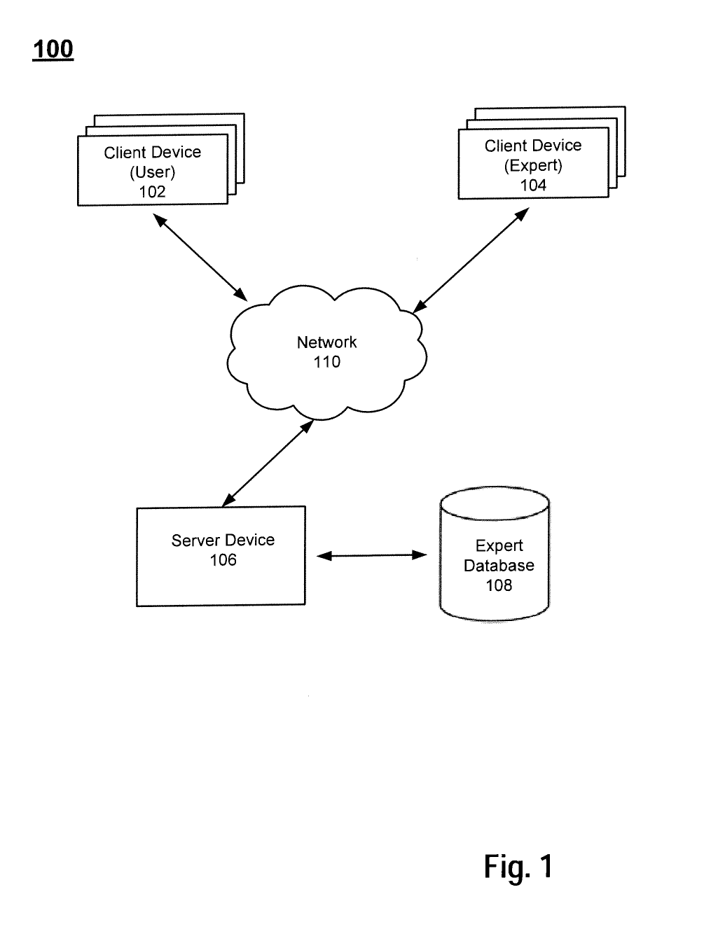

FIG. 1 illustrates a block diagram of an example system 100 of providing expert elicitation with an illustrative implementation. Components of the system 100 can communicate via at least one computer network such as the network 110. The system 100 can include at least one client device 102, at least one client device 104, at least one server device 106, and at least one database 108.

The client device 102 can submit a request for expert opinion via the network 110 to the server device 106. The server device 106 can receive the request from the client device 102, process the request, and provide the expert opinion back to the client device 102. The server device 106 can access the database 108 to obtain information of experts who may be in the same field as the requested expert opinion submitted by the client device 102. System 100 may also include a client device 104 which can be used by an expert to communicate with the server device 106.

The network 110 may be any type of computer network that relays information between the server device 106, the client device 102, and the client device 104. The network 110 may include the Internet and/or other types of data networks, for example a local area network (LAN), a wide area network (WAN), a cellular network, satellite network, or other types of data networks. Moreover, the network 110 may include any number of computing devices that are configured to receive and/or transmit data within the network 110. The network 110 may further include any number of hardwired and/or wireless connections. For example, the client device 102 may communicate wirelessly, for example via WiFi, cellular, radio, etc., with a transceiver that is hardwired to other computing devices in the network 110.

The client devices 102 and 104 are electronic devices that are capable of sending and receiving data over the network 110. Example of client devices include personal computers, mobile communication devices, tablet computers, smart phones, and other devices. A tablet computer may be a mobile computer, larger than a mobile phone or personal digital assistant, integrated into a flat touch screen and primarily operated by touching the screen. Tablet computers often use an onscreen virtual keyboard, a passive stylus pen, or a digital pen, rather than a physical keyboard. A client device typically includes a user application, such as a web browser, to facilitate the sending and receiving of data over the network 110.

The server device 106 is an electronic device connected to network 110 and is capable of sending and receiving date over network 110. For example, server device may be computer servers, such as FTP servers, file sharing servers, web servers, etc., or any other devices that include a processing circuit.

Each of the electronic devices shown in FIG. 1 (i.e., the client devices 102, 104 and the server device 106) includes one or more processors (i.e., processing circuits) and memory. Memory may include electronic, optical, magnetic, or any other storage or transmission device capable of providing processors with program instructions. Memory may also include read-only memory (ROM), CD-ROM, DVD, memory chip, tape, floppy disk, magnetic disk, ASIC, FPGA, random-access memory (RAM), electrically-erasable ROM (EEPROM), erasable-programmable ROM (EPROM), flash memory, optical media, or any other suitable memory from which processors can read instructions. Processors may include microprocessors, field-programmable gate arrays (FPGA), application-specific integrated circuits (ASIC), etc., or combinations thereof. The memory stores machine instructions that, when executed by a processor, causes the processor to perform one or more of the operations described herein. The instructions may include code from any suitable computer-programming language, for example Java, C, C++, C#, COBOL, Visual Basic, JavaScript, Perl, Python, Scheme, Lisp etc.

In one implementation, the database 108 could be a separate device from the server device 106. In another implementation, the database 108 may be considered as one device with the server device 106 (e.g., a memory device within the server device 106). The database 108 may include one or more data structures and may operate according to a relational database system, such as MySQL, or other structured query language databases. In one implementations, the database 108 may reside within the same system as the server device 106. Although the database 108 in FIG. 1 is not shown as being connected to the network 110, in other implementations, the database 108 can be connected to and accessed through the network 110. For example, in one implementation, the database 108 may be a networked online storage in which data may be stored on virtualized pools of storage which may be hosted by third parties (e.g., cloud storage).

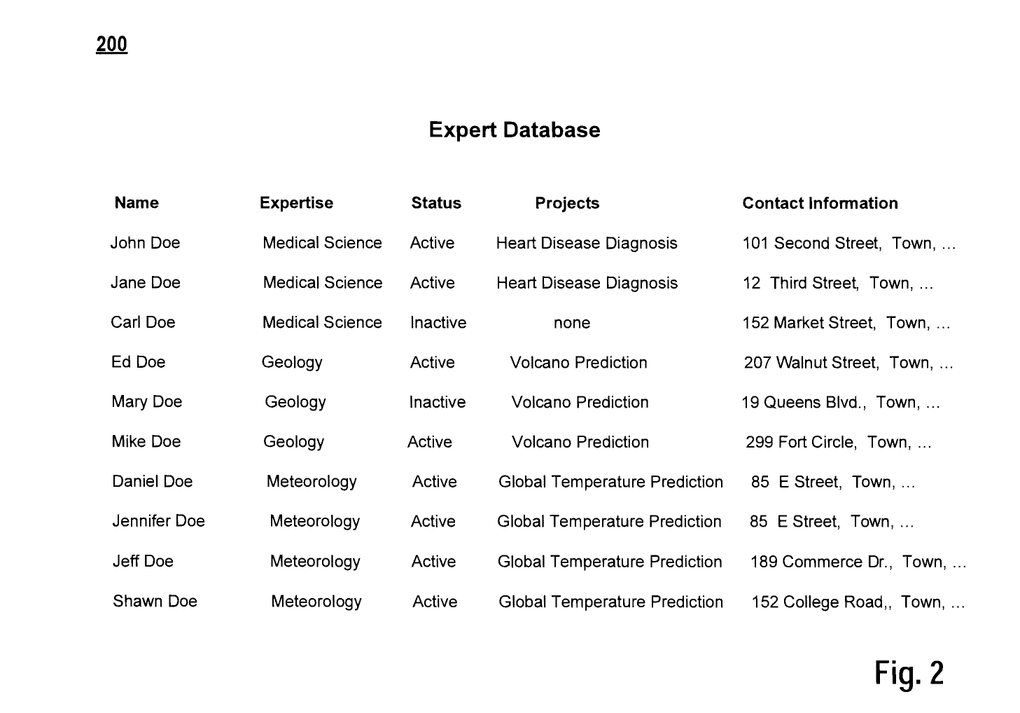

In one implementation, expert information may be stored in an expert database, such as database 108. FIG. 2 illustrates an exemplary expert database user interface according to an illustrative implementation. For example, in this implementation, the database includes at least one of the following data fields for each expert: areas of expertise, contact information, active and inactive status, and projects worked and working on. Users of the database may select experts based on their expertise and active and inactive status. In other implementations, additional, fewer, or different data fields may be included in the database.

In one implementation, a request for an expert opinion may be submitted by client device 102 to server device 106 via the network 110. For example, a user who operates client device 102, such as a personal computer or a smart phone, may submit a request for predicting temperature in Philadelphia on the 30th of next month.

In one implementation, upon receiving the request for the expert opinion, a plurality of experts in the same field as the requested expert opinion may be selected. For example, a list of experts in the fields of meteorology may be selected if the request is to predict temperature in Philadelphia on the 30th of next month. In one implementation, the experts may be selected from an expert database, such as the database 108, if the database contains sufficient experts of the targeted field. For example, the experts may be selected based on their past performance and projects conducted. In another implementation, the experts may be selected by other means, such as through scientific journals, etc. The experts selected may then be added to the database 108.

In one implementation, a plurality of seed questions and target questions may be generated based on the request. For example, a seed question may be a question for which the answer is known, and thus can be used to evaluate the expert's proficiency in the field. A target question may be a question rephrased from the request for the expert opinion submitted by the client device 102. In one implementation, seed questions may be selected from a database (e.g., database 108) by searching the database if suitable seed questions are available in the database (e.g., from seed questions of previous similar projects). If the database does not contain sufficient suitable seed questions, seed questions may be generated using a user interface. In one implementation, seed questions may be between 10 and 20 in number depending on the nature of the project. In other implementations, the number of seed questions may be more or fewer.

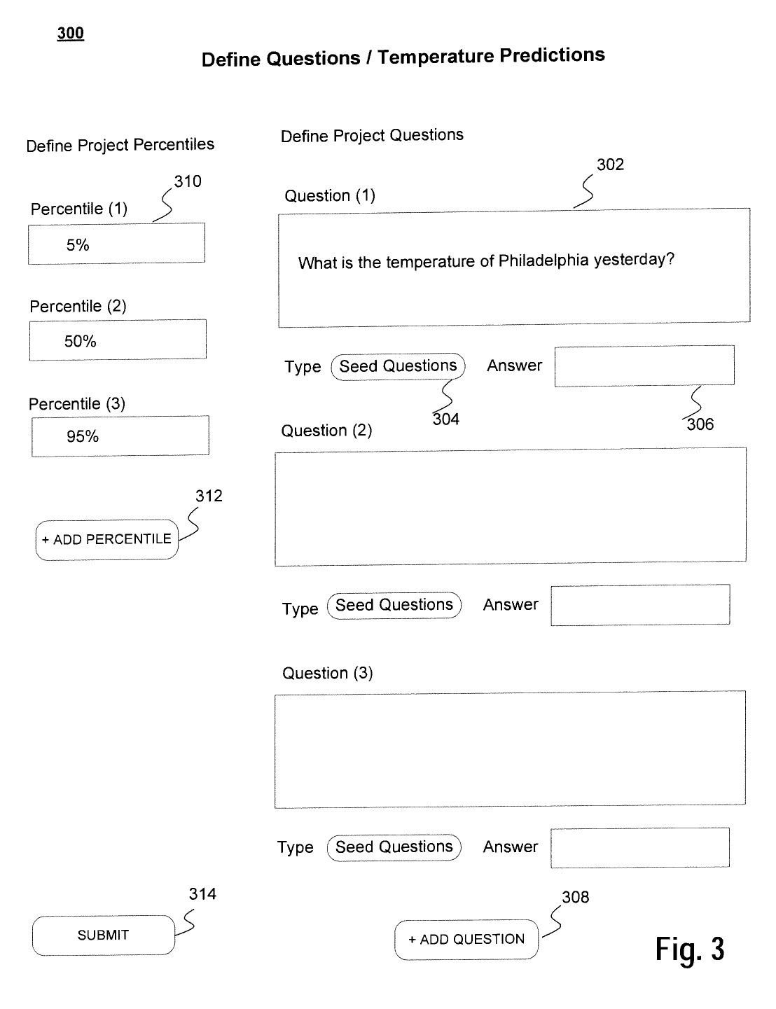

FIG. 3 illustrates an exemplary user interface 300 for generating seed questions and target questions with an illustrative implementation. For example, the user interface 300 can be displayed on a web browser running on the server device 106 or as part of a locally-run application configured to operate the expert elicitation process. In FIG. 3, a number of question fields 302 may be provided for an analyst to enter questions. For example, an analyst may enter the question “what is the temperature of Philadelphia yesterday?” in field 302.

In one implementation, a question type field 304 may be provided for the analyst to select whether the question she defined in field 302 is a seed question or a target question. If the question type is a seed question, an answer field 306 may be provided for the analyst to enter an answer because a seed question is a question for which the answer is known. On the other hand, if the question type is a target question, the analyst may leave the answer field empty because there is no answer available. In one implementation, an add question button 308 may be provided for adding any additional question fields. For example, each time when the add question button 308 is clicked, a question field may be added to the user interface 300.

In FIG. 3, a number of project percentile fields 310 may also be provided. In one implementation, an answer to either a seed question or a target question may include a set of estimates to the true answer and an uncertainty metric corresponding to each estimate. The uncertainty metric may be represented in the format of percentile. For example, for the question “what is the temperature in Philadelphia on the 3^{rd} of February in 2007,” an answer may be structured in the following way:

| Estimates: | 10° F. | 20° F. | 40° F. | 50° F. | 60° F. |
|---|---|---|---|---|---|
| Uncertainty metric: | 5% | 25% | 50% | 75% | 95% |

In the above example, the expert's answer may indicate that she is 5% sure that the temperature is 10 degrees Fahrenheit or below, 25% sure that the temperature is 20 degrees Fahrenheit or below, 50% sure that the temperature is 40 degrees Fahrenheit or below, and so on.

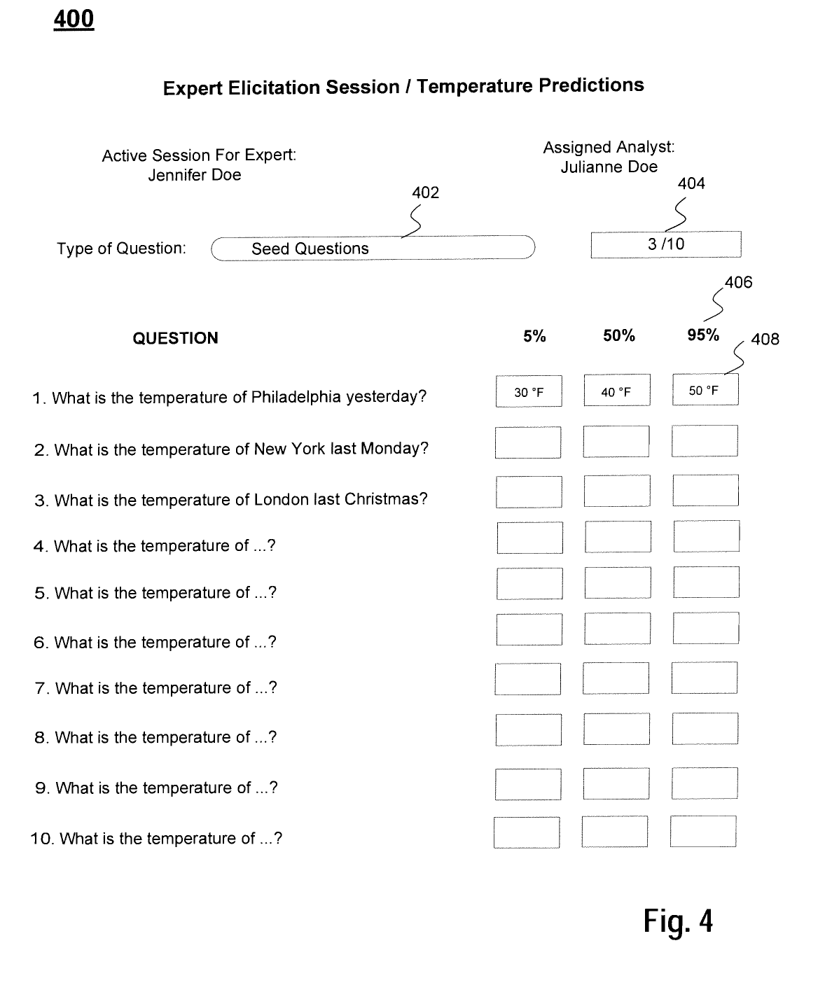

In FIG. 3, the user (e.g., an analyst) of the interface 300 can define how many percentiles (representing the uncertainty metrics) to be used and the value of each percentile. For example, in FIG. 3, there are three percentile fields 310. An analyst can add more percentile fields by clicking the add percentile button 312. In each of the percentile fields 310, the user can define what the percentile is. For example, the user can define the project percentiles to be 5%, 50%, and 95%. In one implementation, a submit button 314 may be provided. For example, when the user of the interface shown in FIG. 3 completed the tasks of defining project questions and defining project percentiles, the user can click the submit button to submit the questions and percentiles. In one implementation, once the submit button is clicked, an elicitation session user interface (e.g., FIG. 4) may be generated.

In one implementation, the plurality of seed questions and target questions generated using the user interface 300 may be sent to the experts selected. For example, the server device 106 may send the seed questions and target questions to one or more of the client device 104 via the network 110. The client device 104 can be operated by an experts selected and can communicate with the server device 106 through an elicitation session. The elicitation session (or question and answer session) can be implemented in various ways. For example, in one implementation, a session between an analyst on the server side and an expert on the client side may be conducted through a user interface.

FIG. 4 illustrates an exemplary user interface 400 of an elicitation session according to an illustrative implementation. For example, the user interface 400 can be displayed on a web browser running on the client device 104 operated by an expert. The user interface 400 may also be displayed on server side. For example, the user interface 400 can be displayed on the server device 106 or on a personal computer operated by an analyst on the server side. In FIG. 4, a type of question field 402 may be provided, indicating whether the questions shown are target questions or seed questions. In one implementation, a field 404 may be provided to indicate the number of estimates/uncertain metrics (e.g., percentiles) and questions. For example, “ 3/10” is displayed in the field 404, indicating there are 10 questions and 3 estimates/uncertain metrics. In this implementation, three percentiles 406 (uncertain metrics) are shown (e.g., 5%, 50%, 95%). Each of the percentiles 406 may correspond an estimate input field 408 for each question.

In one implementation, as described previously, the answer to each question includes a set of estimates to the true answer and their corresponding uncertainty metrics. In one implementation, the seed questions and target questions may be structured in the same format. For example, as shown in FIG. 4, for the question of “what is the temperature of Philadelphia yesterday,” an expert may answer that she is 5% sure that the temperature is 30 degrees Fahrenheit and below, 50% sure that the temperature is 40 degrees Fahrenheit and below, and 95% sure that the temperature is 50 degrees Fahrenheit and below.

In one implementation, the elicitation session may be accompanied with a face-to-face video between the expert and the analyst (e.g., through a webcam, etc.). A webcam can be a video camera that feeds its images in real time to a computer or computer network, often via USB, ethernet, or Wi-Fi. In one implementation, a training session may be conducted before the real elicitation session. The training session may be conducted in the same way as the elicitation session described and shown in FIG. 4.

In one implementation, the answers to the seed questions and the target questions may be received from the experts. For example, the server device 106 may receive the answers to the seed questions and the target questions from one or more client devices 104 via the network 110. In one implementation, after the answers to the seed questions and target questions are received, a performance-based weight may be generated for each expert. In one implementation, the performance-based weight may be determined by a calibration score and an information score. For example, the performance-based weight may be generated by combining the calibration score and the information score of each expert.

In one implementation, the calibration score and the information score may be calculated based on the correct answers (e.g., sample experimental results) to the seed questions and the expert's answers to the seed questions. For example, the server device 106 may compare the expert's answers to the seed questions with the sample experimental results to the seed questions. In one implementation, the calibration score may indicate how likely the expert's answers (in the format of estimates and uncertain metrics as shown in FIG. 4) match the sample experimental results. Thus, the closer the estimates match the sample experimental results, the higher the calibration score.

The information score may indicate how concentrated the expert's estimates are. The narrower the distribution/range of the estimates, the higher the information score. For example, in the temperature example discussed above, an expert who is 5% sure the temperature is 20 degrees and below and 95% sure that the temperature is 30 degrees and below will get a higher information score than an expert who is 5% sure the temperature is 0 degrees and below and 95% sure that the temperature is 40 degrees and below, because the former has a narrow range (20 to 30) than the latter (0 to 40).

In one implementation, both the calibration score and the information score may be calculated based on the answers to all the seed questions. In another implementation, the calibration score may be calculated based on the answers to all the seed question while the information score may be calculated based on only a given seed question.

In one implementation, instead of using the answers to the seed questions to determine the performance-based weight, an equal weight may be assigned to each expert. For example, every expert may get a weight of 1.0. In another implementation, a user specified weight may be used. For example, a weight may be assigned based on the experts' experience. For instance, an expert with a 10-year experience in the field may be assigned a weight of 0.5 while an expert with a 6-year experience may be assigned a weight of 0.2. The values of weight used herein are only for the purpose of illustration. In one implementation, the performance-based weight for each expert may be normalized, for example, between 0 to 1 or between 0% to 100%, etc.

In one implementation, a robustness check may be utilized when generating the performance-based weight. For example, a particular seed question may be excluded from the plurality of seed questions when generating the performance-based weight. In another example, an particular expert may be excluded from the plurality of experts when generating the weight. Then, the result with the particular seed question (or the particular expert) may be compared with the result without the particular seed question (or the particular expert) to evaluate the importance of that particular seed question (or that particular expert).

In one implementation, experts may be told that they are competing with other experts in the process and will be rewarded if their performance meets a certain benchmark. For example, experts may be told that if their answers to the target questions turn out to be close to the true answer, they will get a reward. The reward could be in any forms, for example an expert may get a star in her record in the expert database, indicating her professional proficiency is high. An expert who has a high level of proficiency in the database may more likely be invited to further expert elicitation processes.

In one implementation, after the performance-based weight of each expert is determined, the weights can be applied to the answers of the target questions to generate an expert opinion. For example, the expert opinion may be generated by combining all the experts' answers to the target questions with the performance-based weights applied. In one implementation, the expert opinion may be in the same format as the answers shown in FIG. 4 (e.g., a set of estimates with uncertainty metrics).

In one implementation, the expert opinion may be provided to the user. For example, the server device 106 may provide the expert opinion to the user device 102 via the network 110.

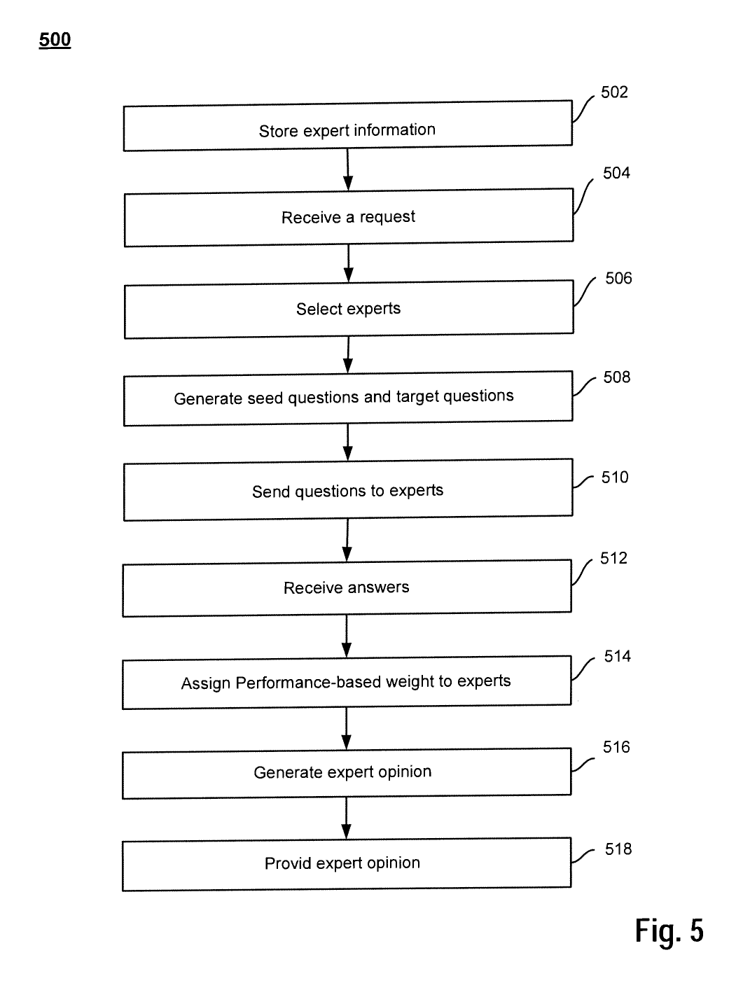

FIG. 5 is a flow diagram of a process for providing expert elicitation with an illustrative implementation. The process 500 can be implemented on a computing device such as the server device 106 (FIG. 1). In one implementation, the process 500 may be encoded on a computer-readable medium that contains instructions that, when executed by a computing device, may cause the computing device to perform operations of the process 500.

The process 500 may include, at step 502, storing a plurality of expert information to an expert database. In one implementation, each of the expert information may include at least one of areas of expertise of the expert, contact information of the expert, a field indicating whether the expert has an active or inactive status, and/or projects that the experts is working on or worked on. At step 504, a request for an expert opinion may be received. For example, the request may be received by a server device from a client device via a computer network. For example, a request of predicting temperature of Philadelphia on the 30th of next month may be made.

At step 506, a plurality of experts may be selected based on the information in the request. For example, a list of experts in the field of meteorology may be selected. In one implementation, the experts may be selected from the expert database if the database contains sufficient experts of the related field. In another implementation, the experts may be selected by other means, such as through scientific journals, etc. At step 508, a plurality of seed questions and target questions may be generated. For example, the seed questions may be selected from a database or generated using a user interface.

At step 510, the plurality of seed questions and target questions are sent to each of the experts selected in step 506. For example, the questions can be sent from the server device to a number of client devices. At step 512, answers to the seed questions and target questions may be received. For example, answers may be received by the server device from the number of the client devices. At step 514, based on the answers to the seed questions, a performance-based weight may be assigned to each expert who answered those questions. For example, the performance-based weight may be generated by combining a calibration score and an information score of each expert. At step 516, the expert opinion may be generated based on the performance-based weight assigned to each expert in step 514 and the answers to the target questions from each expert. At step 518, the expert opinion may be provided to the user via the computer network.

The foregoing description of example implementations have been presented for purposes of illustration. It is not intended to be exhaustive or to limit the features to the precise form disclosed. The functionality described may be implemented in a single executable or application or may be distributed among modules that differ in number and distribution of functionality from those described herein. Furthermore, the order of execution of the functions may be changed depending on the implementations. The operations described in this specification and implementations of the subject matter can be implemented in any type of hardware, or digital electronic circuitry, or firmware, or computer software embodied on a computer-readable medium, etc. The process or functionality can be performed by one or more programmable processors executing one or more computer programs.

The computer system or computer device that can be used to implement the electronic devices described in this specification (e.g., the client devices 102, 104, and server device 106) includes a bus or other communication component for communicating information and a processor or processing circuit coupled to the bus for processing information. The computing system or computing device also includes a main memory coupled to the bus for storing information and instruction to be executed by the processor. The computing system or computing device may further include a storage device, such as read-only memory, etc. for storing static information and instruction for the processor. The computing system or computing device may include a display (e.g., liquid crystal display, cathode ray tube, etc.) for displaying information to users of the computer system. The computing system or computing device may further include an input device (e.g., a keyboard, a mouse, a touch screen, etc.) for communicating information and command selection to the processor. The computing system described in this specification can include clients and servers. For example, the server device 106 can include one or more servers in one or more data centers. The term server or client can include all kinds of machines, apparatus, devices for processing data, including by way of example a programmable processor, a computer, a system on a chip, or multiple ones, or combinations, of the foregoing.

The subject matter described in this specification can be implemented as one or more computer programs embodied on a computer-readable medium. Computer-readable medium can be an electronic holding place or storage for information so that the information can be accessed by processors as known to those skilled in the art. Computer-readable medium can include any type of machine readable storage device, any type of machine readable storage substrate, any type of random access memory (RAM), any type of read only memory (ROM), any type of flash memory, magnetic storage devices, hard disk, floppy disk, magnetic strips, optical disks, smart cards, flash memory devices, and any type of composition of matter effecting a machine readable propagated signal, or a combination of one or more of them.

A computer program can be deployed in any form, for example stand-alone program or as module, object, component, subroutine, etc. A computer program written in any form of programming language, for example procedural or declarative languages, interpreted or compiled languages, etc. Examples of programming languages include, but not limited to Java, C, C++, C#, COBOL, Visual Basic, JavaScript, Perl, Python, scheme, lisp etc. Various processors can be used to execute a computer program, for example, general and special purpose microprocessors, and anyone or more processor of any kind of digital computer.

For the purposes of this disclosure and unless otherwise specified, “a” or “an” means “one or more”. The word “or” may be construed as inclusive so that any terms described using “or” may mean any of a single, more than one, and all of the described terms. The word “example” is used in this specification to mean serving as an example, instance, or illustration. Any aspect or design described herein as “example” is not necessarily to be construed as preferred or advantageous over other aspects or designs. Furthermore, any implementation disclosed in this specification may be combined with any other implementation or embodiment, and references to “an implementation,” “other implementation,” “some implementation,” “various implementation,” or the like are not necessarily mutually exclusive and are intended to mean that a specific feature, characteristic, structure described in connection with the embodiment may be included in at least one implementation or embodiment. Those terms as used in this specification are not necessarily all referring to the same embodiment.

The systems and methods described in this specification can be implemented in other specific forms without departing from the characteristics thereof. The embodiments were described and chosen for the purpose of explaining and as practical applications to enable one skilled in the art to utilize the specification in various embodiments and with various modifications as suited to the particular use contemplated. It is intended that the scope of the systems and methods described herein be defined by the claims appended hereto and their equivalents.

What is claimed is:

1. A computer-implemented method of providing expert elicitation via a computer network, comprising:
storing a plurality of expert information to an expert database, wherein the expert information comprises at least one of areas of expertise, contact information, active and inactive fields, or projects working and worked on;
receiving, by at least one processing circuit, a request for an expert opinion from a user via the computer network;
selecting a plurality of experts based on information in the request of the user;
generating a plurality of seed questions and target questions based on information in the request of the user;
sending the plurality of seed questions and target questions to each of the experts selected;
receiving answers of the seed questions and the target questions from each of the experts;
assigning, by the at least one processing circuit, a performance-based weight to each of the experts based on the answers of the seed questions;
generating, by the at least one processing circuit, the expert opinion based on the performance-based weight of each of the experts and the answers to the target questions; and
providing the expert opinion to the user.

2. The method of claim 1, wherein each of the answers comprises:
a plurality of estimates; and
a plurality of uncertain metrics, wherein each uncertain metric corresponding to an estimate in the plurality of estimates.

3. The method of claim 2, wherein the performance-based weight is determined by a calibration score and an information score, wherein the calibration score indicates the likelihood that the expert's estimate matches a sample experimental result and the information score is determined by the expert's uncertainty metrics.

4. The method of claim 3, wherein the assigning further comprises:
if the estimate to the seed question matches the sample experimental result, assigning a higher performance-based weight; and
if the estimate to the seed question does not match the sample experimental result, assigning a lower performance-based weight.

5. The method of claim 1, wherein the seed questions are between 10 and 20 in number.

6. The method of claim 1, further comprising searching the expert database for seed questions related to the expert opinion requested by the user.

7. The method of claim 1, wherein the experts are selected based on past performance of the experts and projects conducted by the experts.

8. The method of claim 1, wherein the expert in the database will be assigned a reward if the performance of the expert meets a certain benchmark.

9. A system of providing expert elicitation via a computer network, comprising:
one or more processing circuits configured to:
store a plurality of expert information to an expert database, wherein the expert information comprises at least one of areas of expertise, contact information, active and inactive fields, or projects working and worked on;
receive a request for an expert opinion from a user via the computer network;
select a plurality of experts based on information in the request of the user;
generate a plurality of seed questions and target questions based on information in the request of the user;
send the plurality of seed questions and target questions to each of the experts selected;
receive answers of the seed questions and the target questions from each of the experts;
assign a performance-based weight to each of the experts based on the answers of the seed questions;
generate the expert opinion based on the performance-based weight of each of the experts and the answers to the target questions; and
provide the expert opinion to the user.

10. The system of claim 9, wherein each of the answers comprises:
a plurality of estimates; and
a plurality of uncertain metrics, wherein each uncertain metric corresponding to an estimate in the plurality of estimates.

11. The system of claim 10, wherein the performance-based weight is determined by a calibration score and an information score, wherein the calibration score indicates the likelihood that the expert's estimate matches a sample experimental result and the information score is determined by the expert's uncertainty metrics.

12. The system of claim 1, wherein the one or more processing circuits are further configured to search the expert database for seed questions related to the expert opinion requested by the user.

13. The system of claim 1, wherein the experts are selected based on past performance of the experts and projects conducted by the experts.

14. The system of claim 1, wherein the expert in the database will be assigned a reward if the performance of the expert meets a certain benchmark.

15. A non-transitory computer-readable medium having machine instructions stored therein, the instructions being executable by one or more processors to cause the one or more processors to perform operations comprising:
storing a plurality of expert information to an expert database, wherein the expert information comprises at least one of areas of expertise, contact information, active and inactive fields, or projects working and worked on;
receiving a request for an expert opinion from a user via a computer network;
selecting a plurality of experts based on information in the request of the user;
generating a plurality of seed questions and target questions based on information in the request of the user;
sending the plurality of seed questions and target questions to each of the experts selected;
receiving answers of the seed questions and the target questions from each of the experts;
assigning a performance-based weight to each of the experts based on the answers of the seed questions;
generating the expert opinion based on the performance-based weight of each of the experts and the answers to the target questions; and
providing the expert opinion to the user.

16. The non-transitory computer-readable medium of claim 15, wherein each of the answers comprises:
a plurality of estimates; and
a plurality of uncertain metrics, wherein each uncertain metric corresponding to an estimate in the plurality of estimates.

17. The non-transitory computer-readable medium of claim 16, wherein the performance-based weight is determined by a calibration score and an information score, wherein the calibration score indicates the likelihood that the expert's estimate matches a sample experimental result and the information score is determined by the expert's uncertainty metrics.

18. The non-transitory computer-readable medium of claim 15, the instructions further comprising searching the expert database for seed questions related to the expert opinion requested by the user.

19. The non-transitory computer-readable medium of claim 15, wherein the experts are selected based on past performance of the experts and projects conducted by the experts.

20. The non-transitory computer-readable medium of claim 15, wherein the expert in the database will be assigned a reward if the performance of the expert meets a certain benchmark.
